(19) United States
(12) Patent Application Publication
(10) Pub. No.: US 2004/0056125 A1
(43) Pub. Date: Mar. 25, 2004

(54) Process for continuously recovering waste paint and processor therefor

(76) Inventor: Kuniya Sonehara, Tokyo (JP)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/667,754

(22) Filed: Sep. 22, 2003

(30) Foreign Application Priority Data
Sep. 20, 2002 (JP) 2002-274690

(51) Int. Cl. B02C 19/12

(52) U.S. Cl. 241/21; 241/46.17

(57) ABSTRACT

The present invention provides a process for continuously recovering a waste paint comprising: feeding a booth-circulating water containing paint particles discharged from a paint booth to a first separation tank, and adding a dispersing agent and a floatation agent into the first separation tank to finely divide and disperse the paint particles for floating; feeding a liquid containing the paint particles into a second separation tank to roughly separate a liquid containing paint flocculate and a liquid containing no paint flocculate; transferring the liquid containing paint flocculate roughly separated in the second separation tank to a foreign-matter separation tank to remove a foreign matter contained in the liquid containing paint flocculate by retaining the liquid in the foreign-matter separation tank; and separating the paint flocculate from the liquid containing paint flocculate having been subjected to the removing treatment of the foreign matter to collect the paint flocculate. The process for continuously recovering a waste paint brings about highly efficient recovery of the waste paint, reduction of the running costs and production of waste paint having high quality, and can be applied to the preparation of recycled products having high quality without causing trouble of the processor for the preparation of the recycled products.

### BACKGROUND OF THE INVENTION

1. Field of the Invention

The present invention relates to a process and processor for continuously recovering a waste pain discharged from processes such as coating process of applying paint to a vehicle body.

2. Description of the Related Art Including Information Disclosed Under 37 CFR 1.97 and 1.98

As an example of a conventional processor for continuously recovering a waste pain as mentioned above, a processor shown in FIG. 1 has been known. In the recovery processor, excess paint mist (paint particles) that has not attached onto a body 101 to be coated in a painting booth 100 is captured by booth-circulating water overflowed from a liquid-feeding gutter 102 together with air at a Venturi 104 of a water-washing system 103, and fed to a first separation tank 105.

The first separation tank 105 is provided with a receiving tank 105a accommodating booth-circulating water containing paint particles discharged from the painting booth 100 and a stirring tank 105b for stirring the booth-circulating water. The receiving tank 105a and the stirring tank 105b are separated each other by a partition plate (screen) 106.

A polymer-type flocculation agent is added into the receiving tank 105a at a flocculation agent tank 107, and in the receiving tank 105a the paint particles are flocculated and floated with capturing air. Then, the floated paint particles (i.e., paint flocculate) are overflowed into the stirring tank 105b. In contrast, the booth-circulating water in the receiving tank 105a is fed to the liquid-feeding gutter 102 in the painting booth 100 through a circulating pipe 109 by a pump 108 whereby the booth-circulating water can be used in cycle.

A stirring mixer 110 and an accumulated pit 111 are provided in the stirring tank 105b, in which the booth-circulating water is stirred with the stirring mixer 110 to float up the paint particles precipitated at the bottom of the stirring tank 105b, and the floated paint particles are accumulated in the accumulated pit 111.

A liquid containing the floated paint particles accumulated in the accumulated pit 111 is fed to a second separation tank 115 through a pipe 113 by a pump 112, and simultaneously a floatation agent is added to the second separation tank 115 through a pipe 113 from an agent tank 116, whereby the paint particles are floated up under application of pressure.

The liquid containing paint particles floated in the second separation tank 115 is discharged (fed) using a taking-out system to a sludge retaining tank 118, while the liquid in the second separation tank 115 being circulated to the first separation tank 105.

The liquid containing paint particles discharged in the sludge retaining tank 118 is fed to a centrifugal machine 121 through a pipe 120 by a pump 119, and subjected to the centrifugation treatment, whereby a resultant solid paint flocculate is collected in the paint flocculate collecting vessel 122 while water part is circulated to the first separation tank 105.

Further, there has been known another recovery processor, in which an alkali agent and a flocculation agent are added to booth-circulating water containing paint particles discharged from a painting booth, theses are mixed to be fed to a first separation tank, the paint particles are flocculated with capturing air therein to be floated in the first separation tank, the liquid containing the floated paint particles (paint flocculate) is fed to a second separation tank, and the booth-circulating water in the first separation tank is mixed with the floated liquid containing paint particles on the way of a feeding root to the painting booth to be circulated to the painting booth (see JP-A07-148451 (pages 3 to 5 and FIG. 1)).

In this recovery processor, the paint particles floated up in the second separation tank is scraped to be discharged to a sludge storage tank, the liquid containing paint particles in the second separation tank is concentrated and the concentrated liquid is subjected to the centrifugation treatment using a centrifugal separator similarly as above, and thereafter the resultant paint flocculate in the form of solid is collected in the paint flocculate-collecting vessel while water part is circulated to the first separation tank.

### SUMMARY OF THE INVENTION

In any of the above-mentioned conventional recovery processors, addition of the flocculation agent in the first separation tank renders the paint particles sticky, whereby the paint particles capture air therein (i.e., air is enveloped in the paint particles) and the paint particles capturing air (i.e., paint flocculate) rise up (i.e., float up). Therefore if air escapes from the paint particles, the paint particles are apt to precipitate on the bottom of the tank. Thus, it is required to install a stirring mixer to float up the precipitated particles with stirring, which means increase of the cost of the equipment.

Even if the booth-circulating water is stirred with the stirring mixer, it is difficult to easily float up the precipitated paint particles. Hence, recovery efficiency of paint waste is reduced, and the reduction brings about frequent cleaning of the first separation tank to increase the running costs.

Further, since the paint particles fed to the centrifugal separator have sticky property due to use of a flocculation agent, the paint flocculate (i.e., flocculated paint particles) adheres to the inner wall of the centrifugal separator. This adherence makes it difficult to reduce water content of the paint flocculate and therefore it requires more time in operation for separating water from the paint flocculate in a later process,

Furthermore, the conventional recovery processors are not configured to remove foreign matter such as wastepaper mixed in the liquid containing paint flocculate. Thus when the foreign matter is mixed in the centrifugal separator, the separator is operated under excess load to occasionally be caused trouble. Therefore frequency of maintenance of the separator is necessarily increased to enhance the running costs.

In case the paint flocculate is intended to be recycled in 100% to attain zero-emission of the waste paint, the foreign matter mixed in the paint flocculate may cause trouble to a processor for the preparation of recycled product and may reduce quality of the recycled product itself.

In view of the above-mentioned problems, a first object of the invention is to provide a process for continuously recovering a waste paint which brings about highly efficient recovery of the waste paint, reduction of the running costs and production of waste paint having high quality, and which can be used in a process for the preparation of recycled products having high quality without causing trouble to the processor for the preparation of the recycled products.

Further, a second object of the invention is to provide a processor for continuously recovering a waste paint in which the above-mentioned process can be carried out at a low price in the cost of equipment.

The present invention to attain the first object is provided by a process for continuously recovering a waste paint comprising:

feeding a booth-circulating water containing paint particles discharged from a paint booth to a first separation tank, and adding a dispersing agent and a floatation agent into the first separation tank to finely divide and disperse the paint particles for floating;

feeding a liquid containing the paint particles into a second separation tank to roughly separate a liquid (layer) containing paint flocculate and a liquid (layer) containing no paint flocculate by flocculating the paint particles to form the paint flocculate;

transferring the liquid containing paint flocculate roughly separated in the second separation tank to a foreign-matter separation tank to remove a foreign matter contained in the liquid containing paint flocculate by retaining the liquid in the foreign-matter separation tank; and

separating the paint flocculate from the liquid containing paint flocculate having been subjected to the removing treatment of the foreign matter to collect the paint flocculate (a fourth step).

According to the above-mentioned invention (corresponding to claim 1), since the paint particles is forced to be floated by finely dividing using a dispersing agent and a floatation agent, it is possible to reduce the amount of the precipitated paint particles and to render the paint particles nonsticky. Further, before the paint flocculate is separated from the liquid containing paint flocculate to be recovered, the foreign matters are removed from the liquid containing paint flocculate, and hence it is possible to prevent the foreign matter from being mixed in a separator (e.g., centrifugal separator) for separating the paint flocculate and to enhance the quality of the paint flocculate.

Thus, reduction of the amount of the precipitated paint particles brings about enhancement of recovery efficiency of waste paint, accompanied with reduction of the frequency of cleaning operation of the first separation tank and reduction of the frequency of maintenance of the centrifugal separator owing to remove of foreign matter, whereby the running costs can be reduced.

Further, rendering the paint particles nonsticky reduces a water content of the paint particles to be recovered, and brings about reduction of time period for operation for separating water from the paint flocculate in a later process and further provides the paint flocculate having high quality, whereby recycled products having high quality can be obtained without causing trouble to the processor for the preparation of the recycled products.

Another invention to attain the object is provided by the process for continuously recovering a waste paint as defined above, in which, in the second step, the separation of the liquid containing the paint flocculate and the liquid containing no paint flocculate being carried out by floating up the paint particles obtained from the first separation tank under application of pressure.

According to the above-mentioned invention (corresponding to claim 2), it is possible to effectively obtain the paint flocculate because the paint particles are floated (risen) up in the liquid containing paint particles under application of pressure.

The further invention to attain the object is provided by the process for continuously recovering a waste paint as defined above, in which, in the third step, the removal of the foreign matter is carried out by stirring the liquid containing paint flocculate in the foreign-matter separation tank to remove the foreign-matter floated on a surface of the liquid.

According to the above-mentioned invention (corresponding to claim 3), by stirring the liquid containing paint flocculate, the paint flocculate having good quality can be dispersed to float the foreign matter onto a surface of water, whereby it is possible to remove effectively the foreign matter.

The further invention to attain the object is provided by the process for continuously recovering a waste paint as defined above, in which, in the fourth step, the separation of the paint flocculate from the liquid containing paint flocculate is carried out by centrifugation.

According to the above-mentioned invention (corresponding to claim 4), the paint flocculate can be easily separated and recovered from the liquid containing the paint flocculate by the centrifugal separator.

The present invention to attain the second object is provided by a processor for continuously recovering a waste paint comprising:

a first separation tank for accommodating a booth-circulating water containing paint particles discharged from a paint booth;

an agent-adding means for adding a dispersing agent and a floatation agent in the first separation tank to float the paint particles by finely dividing and dispersing them;

a first taking-out means for taking out a liquid containing the paint flocculate floated in the first separation tank;

a circulating means for circulating the liquid in the first separation tank as the booth-circulating water through the paint booth;

a second separation tank for accommodating the liquid taken out by the taking-out means to roughly separate a liquid containing paint flocculate and a liquid containing no paint flocculate by flocculating the paint particles to form the paint flocculate;

second taking-out means for taking out the liquid layer containing paint flocculate roughly separated in the second separation tank;

a foreign-matter separating tank for accommodating the liquid layer containing paint flocculate taken out by the second taking-out means;

a stirring means for stirring the liquid containing paint flocculate accommodated in the foreign-matter separating tank;

a foreign-matter separating means for removing the foreign-matter floated by stirring using the stirring means from foreign-matter separating tank;

a third taking-out means for taking out the paint flocculate having been subjected to the removing treatment of the foreign matter in the foreign-matter separating tank; and

a paint flocculate separation means for separating and recovering the paint flocculate from the liquid containing paint flocculate taken out the third taking-out means.

According to the above-mentioned invention (corresponding to claim 5), the paint particles from the painting booth are finely divided and forced to be risen up using a dispersing agent and a floatation agent in the first separation tank, whereby the amount of the precipitated paint particles can be reduced. Hence, the paint particles can be effectively taken out of the first separation tank without stirring using the first taking-out means, to bring about nonuse of a stirring mixer and hence reduction of the cost of equipment.

The further invention to attain the object is provided by the processor for continuously recovering a waste paint as defined above, in which the foreign-matter separating tank is provided with a scraper for scraping the water surface in the foreign-matter separating tank.

According to the above-mentioned invention (corresponding to claim 6), the water surface in the foreign-matter separating tank is scraped with the scraper, which results in sure removal of the floated foreign-matter.

### BRIEF DESCRIPTION OF THE DRAWINGS

FIG. 1 is a view for showing a principal structure of an embodiment of a processor for continuously recovering waste paint according to the present invention.

FIG. 2 is a view for explaining the treatment in the foreign-matter separation tank shown in FIG. 1.

FIG. 3 is a view for explaining the treatment in the foreign-matter separation tank shown in FIG. 1, similarly to FIG. 2.

FIG. 4 is a view for showing a principal structure of a conventional process or processor for continuously recovering waste paint.

### DETAILED DESCRIPTION OF THE INVENTION

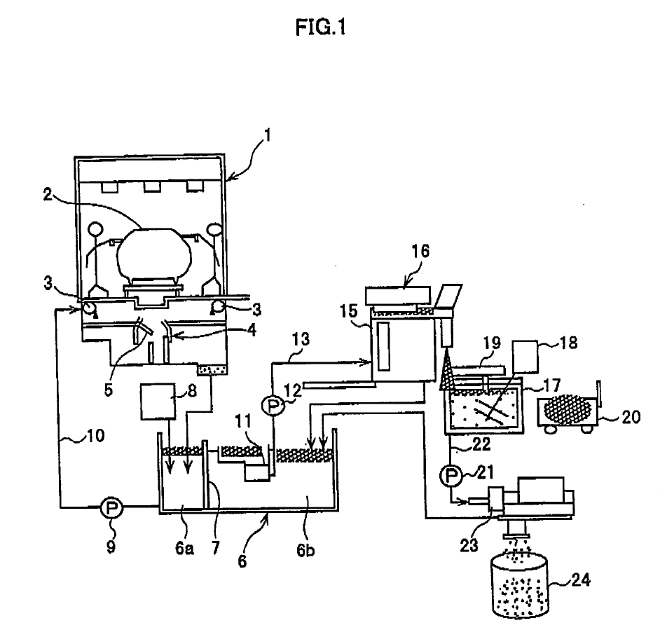

The embodiments of the processor for continuously recovering waste paint according to the invention are explained below with reference to FIGS. 1 to 3.

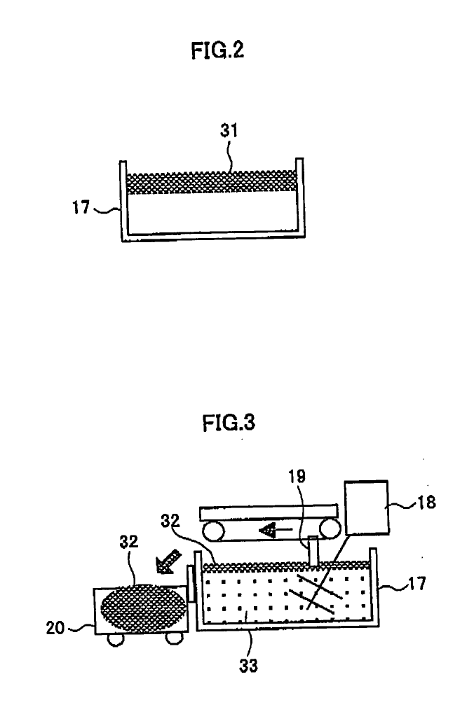

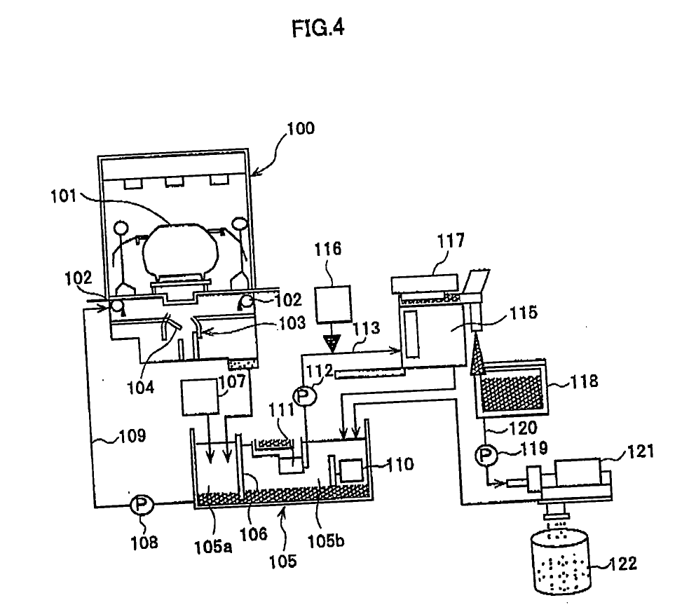

FIG. 1 shows a view for showing a principal structure of an embodiment of a processor for continuously recovering waste paint, and FIGS. 2 and 3 each show a view for explaining the treatment in the foreign-matter separation tank shown in FIG. 1.

In FIG. 1, excess paint mist (paint particles) that has not attached onto a body 2 to be coated (e.g., automobile body) in a painting booth 1 is captured by booth-circulating water overflowed from a liquid-feeding gutter 3 together with air at a Venturi 5 of a water-washing system 4, and discharged from the painting booth 1.

In this embodiment, the booth-circulating water containing the paint particles discharged from the painting booth 1 is fed to a first separation tank 6. In the first separation tank 6, a receiving tank 6a and a taking-out tank 6b which are divided by a partition plate (screen) 7 are provided, and the booth-circulating water containing the paint particles discharged from the painting booth 1 is accommodated in the receiving tank 6a and simultaneously a dispersing agent and a floatation agent having no deflocculating property are added by an agent-adding means 8 to force the paint particles to disperse and float. The dispersing agent serves to finely divide the paint particles and render the particles nonsticky by a hydroxide or oxide (i.e., dispersing agent itself; e.g., modified clay) adsorbing to the surface of the particles, and the floatation agent having no deflocculating property, which generally comprises specific polymer, serves to flocculate the non-sticky paint particles by crosslinking function of the polymer. It is preferred, in the use of the dispersing agent, that the surfaces of the paint particles are neutralized by an inorganic flock agent (e.g., aluminum hydroxide) before the particles are rendered nonsticky by the hydroxide or oxide. The procedure of this paragraph corresponds to a first step.

Examples of the dispersing agent include PALNETTO 1 (Trade name; available from Perker Corporation) or DIAFRESCH AG (Trade name; available from Ryoko Chemical Co., Ltd,); and examples of the floatation agent include PALNETTO 30 (Trade name; available from Perker Corporation) or PALNETTO 150 (Trade name; available from Perker Corporation).

The paint flocculate floated in the receiving tank 6a overflows the partition plate 7 to the taking-off tank 6b, whereas the booth-circulating water in the receiving tank 6a is fed to the liquid-feeding gutter 3 inside the painting booth 1 through a circulating pipe 10 by a pump 9 as means for circulating the booth circulating water, whereby the booth-circulating water can be recycled.

The paint particles overflowed to the taking-out tank 6b are accumulated together with cleaning waster in an accumulating pit 11 which constitutes the first taking-out means, and the paint particles are fed to a second separation tank 15 through a pipe 13 by the pump 12.

In the second separation tank 15, the paint particles are risen up under application of pressure to be roughly separated to a liquid containing paint flocculate (paint flocculation portion) and a liquid containing no paint flocculate (liquid portion). In this step, the paint particles is flocculated to form paint flocculate having preferably the particle size of 0.1 to 1 mm, which is floated up. The liquid containing paint flocculate which is present as the upper layer in the second separation tank 15 is taken out by a second taken-out means 16 to be allowed to stay in a foreign-matter separation tank 17, whereas the liquid containing no paint flocculate (clear water) which is present as a lower layer is recycled to the taking-out tank 6b of the first separation tank 6. The procedure of this paragraph corresponds to a second step.

In a foreign-matter separation tank 17, the liquid containing paint flocculate that has been allowed to stay is stirred by a stirrer 18 (stirring means), and the surface area of the liquid (water) is scraped by a scraper 19 (foreign matter removing means) to be fed to a foreign-matter receiving tank 20. This procedure corresponds to a third step. On the other hand, the liquid containing paint flocculate which is present in the inner part of the foreign-matter separation tank 17 is fed to a centrifugal separator 23 (means for separating paint flocculate) through a pipe 22 by a pump 21 (third taking-out means) and centrifugally separated to recover the paint flocculate in the form of solid in a paint flocculate recovering vessel 24, while water part is recycled to the taking-out tank 6b of the first separation 6. This procedure corresponds to a fourth step.

According to this embodiment, the paint particles from the panting booth 1 is finely divided using the dispersing agent and floatation agent to be forcedly floated up in the receiving tank 6a of the first separation tank 6, whereby the amount of precipitated paint particles can be reduced and the paint particles can be rendered nonsticky.

Further, in the foreign-matter separation tank 17 where the liquid containing paint flocculate from the second separation tank 15 has been fed, the paint flocculate 31 is floated up as shown in FIG. 2 under the condition of no stirring. Otherwise, in case the paint flocculate 31 contains foreign matter, the paint flocculate is floated together with the foreign matter under no stirring. However, in case the liquid in the foreign-matter separation tank 17 is stirred, the foreign matter 23 is floated to the water surface as shown in FIG. 3 to disperse a paint flocculate 33 having high quality in the liquid (water). Therefore, when the foreign matter on the surface area of water is scraped by a scraper 19 to be fed to the foreign-matter receiving tank 20, the foreign matter 32 can be surely and effectively removed and simultaneously the liquid containing paint flocculate having high quality can be fed to the centrifugal separator 23, whereby the paint flocculate having high quality can be recovered.

According to the embodiment of the invention, paint waste, hence, can be effectively recovered without installing a stirring mixer in the first separation tank 6 whereby the cost of the equipment and the running costs can be reduced. Further, by rendering the paint flocculate nonsticky, the water content of the paint flocculate recovered in a paint flocculate recovery vessel 24 can be reduced (e.g., to approx. 30%), and therefore a time period requiring a water separation procedure performed later can be reduced. Moreover, since it is possible to recover the paint flocculate having high quality, a recycled product having high quality can be obtained without giving the production unit any trouble, which makes it possible to attain hundred percent-recycle of the paint flocculate.

The present invention should not be restricted by the above-mentioned embodiment. The invention can be appropriately varied in the constitution so long as the variation is not deviated form the gist of the invention, Examples of the paint flocculation separation means include means for the separation and recovery of the paint flocculation by use of a filter or evaporation of water.

Effect of the invention is summarized as follows:

As described above, in the process for continuously recovering a waste paint according to the invention, the paint particles from the painting booth is finely divided using the dispersing agent and floatation agent to be forcedly floated up, and foreign matter is removed from the liquid containing paint flocculate prior to the separation and recovery of the paint flocculate from the liquid containing paint flocculate, whereby efficiency of the recovery of paint waste cane be enhanced and simultaneously the running costs cane be reduced, and farther it is possible to obtain the paint flocculate having high quality and to apply to the preparation of a recycled product having high quality without giving the production unit any trouble.

Moreover, in the processor for continuously recovering a waste paint according to the invention, paint waste can be effectively recovered without installing a stirring mixer in the first separation tank whereby the cost of the equipment can be reduced.

The disclosure of Japanese Patent Application No. 2002-274690, dated Sep. 20, 2002, including the specification, drawings and abstract, is hereby incorporated by reference in its entirety.

I claim:

1. A process for continuously recovering a waste paint comprising:
feeding a booth-circulating water containing paint particles discharged from a paint booth to a first separation tank, and adding a dispersing agent and a floatation agent into the first separation tank to finely divide and disperse the paint particles for floating;
feeding a liquid containing the paint particles into a second separation tank to roughly separate a liquid containing paint flocculate and a liquid containing no paint flocculate by flocculating the paint particles to form the paint flocculate;
transferring the liquid containing paint flocculate roughly separated in the second separation tank to a foreign-matter separation tank to remove a foreign matter contained in the liquid containing paint flocculate by retaining the liquid in the foreign-matter separation tank; and
separating the paint flocculate from the liquid containing paint flocculate having been subjected to the removing treatment of the foreign matter to collect the paint flocculate.

2. A process for continuously recovering a waste paint as defined in claim 1, the separation of the liquid containing the paint flocculate and the liquid containing no paint flocculate being carried out by floating up the paint particles obtained from the first separation tank under application of pressure.

3. A process for continuously recovering a waste paint as defined in claim 1 or 2, the removal of the foreign matter being carried out by stirring the liquid containing paint flocculate in the foreign-matter separation tank to remove the foreign-matter floated on a surface of the liquid.

4. A process for continuously recovering a waste paint as defined in any of claims 1 to 3, the separation of the paint flocculate from the liquid containing paint flocculate being cared out by centrifugation.

5. A processor for continuously recovering a waste paint comprising:
a first separation tank for accommodating a booth-circulating water containing paint particles discharged from a paint booth;
an agent-adding means for adding a dispersing agent and a floatation agent in the first separation tank to float the paint particles by finely dividing and dispersing them;
a first taking-out means for taking out a liquid containing the paint flocculate floated in the first separation tank;
a circulating means for circulating the liquid in the first separation tank as the booth-circulating water through the paint booth;
a second separation tank for accommodating the liquid taken out by the taking-out means to roughly separate a liquid containing paint flocculate and a liquid containing no paint flocculate by flocculating the paint particles to form the paint flocculate;
a second taking-out means for taking out the liquid layer containing paint flocculate roughly separated in the second separation tank;
a foreign-matter separating tank for accommodating the liquid layer containing paint flocculate taken out by the second taking-out means;
a stirring means for stirring the liquid containing paint flocculate accommodated in the foreign matter separating tank;
a foreign-matter separating means for removing the foreign-matter floated by stirring using the stirring means from foreign-matter separating tank;
a third taking-out means for taking out the paint flocculate having been subjected to the removing treatment of the foreign matter in the foreign-matter separating tank; and
a paint flocculate separation means for separating and recovering the paint flocculate from the liquid containing paint flocculate taken out the third taking-out means.

6. A processor for continuously recovering a waste paint as defined in claim 5, the foreign-matter separating tank being provided with a scraper for scraping the water surface in the tank.
